(19) United States
(12) Patent Application Publication
(10) Pub. No.: US 2014/0044844 A1
(43) Pub. Date: Feb. 13, 2014

(54) WATER SOLUBLE NUTRITIONAL COMPOSITIONS COMPRISING CEREAL BETA-GLUCAN AND RESISTANT STARCH

(71) Applicants: Romel Somavat, Columbus, OH (US); Gaurav C. Patel, Gahanna, OH (US)

(72) Inventors: Romel Somavat, Columbus, OH (US); Gaurav C. Patel, Gahanna, OH (US)

(73) Assignee: ABBOTT LABORATORIES, ABBOTT PARK, IL (US)

(21) Appl. No.: 14/000,114

(22) PCT Filed: Feb. 13, 2012
(86) PCT No.: PCT/US2012/024820

§ 371 Date: Oct. 28, 2013

Related U.S. Application Data
(60) Provisional application No. 61/443,825, filed on Feb. 17, 2011.

(51) Int. Cl. A23L 1/10; A23L 1/29

(52) U.S. Cl. CPC A23L 1/1041; A23L 1/29
USPC 426/285; 426/618; 426/622

(57) ABSTRACT

Disclosed are nutritional compositions comprising agglomerated and/or co-dried particles comprising a cereal beta-glucan and a resistant starch. The agglomerated and/or co-dried particles improve the cold water solubility of the nutritional compositions. The nutritional compositions may be dryblended powdered nutritional compositions including the agglomerated and/or co-dried particles and optionally a Salacia extract.

### TECHNICAL FIELD

The present disclosure relates to water soluble nutritional compositions comprising agglomerated and/or co-dried particles including a cereal beta-glucan and a resistant starch as well as methods of improving the cold water solubility, wetting properties, and dispersibility/mixability properties of powdered nutritional compositions.

### BACKGROUND OF THE DISCLOSURE

Diabetes mellitus is a disorder of carbohydrate metabolism resulting from insufficient production of, or reduced sensitivity to, insulin. In persons who have diabetes, the normal ability of the body to utilize glucose is compromised, thereby increasing blood glucose levels. As more glucose accumulates in the blood, excess levels of glucose are excreted in the urine. Corresponding symptoms of diabetes include increased urinary volume and frequency, thirst, hunger, weight loss, and weakness.

Diabetes is often characterized as either type 1 or type 2. Among the earliest manifestations of type 2 diabetes includes excessive blood glucose levels following a meal due to inadequate first phase insulin secretion. In these individuals, the response to increased blood glucose levels and the modulation of such levels that would otherwise occur in a healthy individual is reduced or absent and thus results in an excessive spike in postprandial blood glucose levels. This is particularly significant given the well established correlation between effective blood glucose control in a diabetic individual and the risk of developing cardiovascular or circulatory diseases or disorders, especially the microvascular and macrovascular complications from such diseases or disorders. As such, controlling postprandial blood glucose levels in the diabetic individual is an important step in reducing the development of cardiovascular or circulatory diseases, and of course the subsequent development of cardiovascular related conditions such as retinopathy, neuropathy, nephropathy, and so forth.

Postprandial glucose levels may be controlled and regulated in prediabetic individuals and individuals with diabetes, and particularly type 2 diabetes, by administering to the individual a nutritional composition comprising a cereal beta-glucan, or a 1-3, 1-4-β-D-linked beta-glucan, in combination with a Salacia extract. When combined in a nutritional composition, the beta-glucan and Salacia extract act synergistically to control and regulate the postprandial glucose levels in an individual such that the absorption of glucose into the bloodstream is retarded and slowed over time. This combination may allow for a reduction in the amount of both ingredients in the nutritional composition and in associated cost savings.

While the nutritional composition comprising the combination of a cereal beta-glucan and a Salacia extract has been shown to reduce post-prandial glucose levels, it has further been found that the cereal beta-glucan component in the composition may have poor solubility and exhibit poor dispersibility and mixability in cold water, making this composition poorly suited for use in ready to drink powder form.

There is therefore a need for water soluble nutritional compositions including cereal beta-glucans, as well as methods of improving the cold water solubility, wetting properties, and dispersibility/mixability of a powdered nutritional composition including a cereal beta-glucan.

### SUMMARY OF THE DISCLOSURE

One embodiment is directed to a nutritional composition comprising particles comprising a cereal beta-glucan and a resistant starch. The particles are selected from the group consisting of agglomerated particles, co-dried particles, and combinations thereof.

Another embodiment is directed to a method of improving the cold water solubility of a powdered nutritional composition comprising a cereal beta-glucan. The method comprises agglomerating the cereal beta-glucan with a resistant starch.

Another embodiment is directed to a method of improving the cold water solubility of a powdered nutritional composition comprising a cereal beta-glucan. The method comprises co-drying the cereal beta-glucan with a resistant starch.

The agglomeration or co-drying of a cereal beta-glucan with a resistant starch, either prior to, during, or after combining (via dryblending or other) of the cereal beta-glucan with the other ingredients of a nutritional composition may improve the cold water solubility, wetting properties, and water dispersibility/mixability of the nutritional composition including the cereal beta-glucan. These improved properties are surprising and unexpected as these properties are not improved in many instances upon the addition of other filler materials with better wetting properties, instantization with lecithin, binding with weighing agents, integration of suitable materials in the matrix of the cereal beta-glucan, or grinding to break the larger fibers. When agglomerated or co-dried with a resistant starch, however, the fines, string-like fibrous structures, and hollow globules present in cereal beta-glucans may be dissolved into its remaining matrix, forming larger particle clusters (agglomerated or co-dried particles) that exhibit improved solubility in water. This agglomeration or co-drying treatment of the cereal beta-glucan may allow for the use of dry powder form nutritional compositions including the cereal beta-glucan, such as ready to drink powder mixes, including ready to drink dryblended powder mixes.

Accordingly, the nutritional compositions and methods of the present disclosure provide nutritional compositions that are highly soluble in water and may, in some embodiments, be able to offer a natural therapeutic option that may contribute to the maintenance of optimal glycemic control in subjects that are prediabetic, have impaired glucose tolerance, or have type 2 diabetes. These benefits are advantageously achieved in such individuals without experiencing many of the complications often associated with the administration of oral anti-diabetic medications.

### BRIEF DESCRIPTION OF THE DRAWINGS

FIG. 1A is a SEM image depicting the dissolving effect of Nutriose® on the fine fibrous structures in Barliv™ as analyzed in Example 3.

FIG. 1B is a SEM image depicting the dissolving effect of Nutriose® on the fine fibrous structures in Barliv™ as analyzed in Example 3.

### DETAILED DESCRIPTION OF THE DISCLOSURE

The various embodiments hereof may include highly water soluble nutritional compositions including a cereal beta-glucan agglomerated or co-dried with a resistant starch, methods of manufacturing those compositions, and methods of using those compositions. These and other essential or optional elements of the various embodiments are described in detail hereinafter.

The term “nutritional composition” as used herein, unless otherwise specified, means a composition suitable for oral administration to an individual but which does not provide sufficient fat, protein and carbohydrate to form a sole or primary source of nutrition in the individual.

The term “meal” as used herein, unless otherwise specified, means a typical selection of food to be consumed by an individual in one sitting, which most typically includes the food consumed at a breakfast, a lunch, or a dinner and which includes a combination of fat, protein, carbohydrates, vitamins, minerals and water typical of such consumption in one sitting, although it is understood that the term “meal” may also include smaller quantities or even less balanced food combinations taken in the form of snacks between breakfast, lunch and or dinner.

The term “cold water solubility” as used herein, unless otherwise specified, means the solubility of a solid (including powderous) nutritional composition (including dryblended compositions) in water at room temperature (18° C.-25° C.) or below. In some embodiments, “cold water solubility” may include solubility of the composition of at least 25%, including from 25% to 100%, including from about 50% to 100%, including from about 75% to 100%.

The term “agglomeration” as used herein, unless otherwise specified, means a process where one component is sprayed in liquid form onto a second component in dry form and hot air or similar is used to dry the end product.

The term “agglomerated particle” as used herein, unless otherwise specified, means at least two components that are intimately joined together and form a mass by agglomeration.

The term “co-drying” as used herein, unless otherwise specified, means a process where one component in liquid form is added to a second component in liquid form and the resulting mixture dried in a spray drier, filter-mat drier, or similar.

The term “co-dried particle” as used herein, unless otherwise specified, means at least two components that are intimately joined together and form a mass by co-drying.

All percentages, parts and ratios as used herein are by weight of the total composition, unless otherwise specified. All such weights as they pertain to listed ingredients are based on the active level and, therefore, do not include solvents or by-products that may be included in commercially available materials, unless otherwise specified.

All numerical ranges as used herein, whether or not expressly preceded by the term “about”, are intended and understood to be preceded by that term, unless otherwise specified.

The nutritional compositions and methods described herein may also be free of any optional or other ingredient or feature also described herein provided that the remaining compositions or methods still contain the requisite ingredients or features as described herein. In this context, the term “free” means the selected composition or method contains or is directed to less than a functional amount of the ingredient or feature, which most typically is less than 1%, including less than 0.5%, including less than 0.1%, and also including zero percent, by weight of such ingredient or feature.

Any reference to singular characteristics or limitations of the present disclosure shall include the corresponding plural characteristic or limitation, and vice versa, unless otherwise specified or clearly implied to the contrary by the context in which the reference is made.

Any combination of method or process steps as used herein may be performed in any order, unless otherwise specifically or clearly implied to the contrary by the context in which the referenced combination is made.

The nutritional compositions and methods may comprise, consist of, or consist essentially of the elements and features of the disclosure described herein, as well as any additional or optional ingredients, components, or features described herein or otherwise useful in a nutritional application.

### Product Form

The nutritional compositions of the present disclosure may be formulated in any known or otherwise suitable product form for oral administration, including powders, dryblended powders, granulated particulates, solid bars, puddings, liquids, and bites. The nutritional compositions are most typically in a solid or powder form, most typically in a powder form that can be reconstituted with an aqueous liquid such as water, tea or other beverage and ingested, or sprinkled over food and ingested.

Other suitable product forms include dry powders obtained by various techniques such as spray drying, filter-mat drying, drum drying, agglomeration, and/or dry blending. Dry powders are especially useful product forms for use herein and are formed by combining the selected ingredients in dry form and thoroughly mixing the combined ingredients to produce a dry blended powder suitable for reconstitution with a liquid or for sprinkling over food prior to consumption. These powder embodiments of the present disclosure, including the dry blended powders, may be packaged in any suitable quantity and in any suitable bulk or single serving container (i.e., 100 grams, 200 grams, 300 grams, 400 grams, 500 grams, or more), including a small volume or single serving sachet or other container comprising from 1 to 20 grams, including from 2 to 10 grams, and also including from 4 to 7 grams, of the powder.

The nutritional products may be packaged in multi-dose or single serving packages. For the nutritional compositions described herein, a serving represents the amount of the composition to be added to an aqueous liquid or food to achieve the desired blood glucose modulation effect, which liquid or food represents an amount to be reasonably consumed by the individual in one sitting. For the powder embodiment described herein, a single serving of the nutritional composition most typically ranges from about 1 to 20 grams, including from 2 to 10 grams, and also including from 4 to 7 grams.

The nutritional products also may contain sufficient ingredients to provide up to 100 kcal per serving, including from 5 kcal to about 90 kcal per serving, and also including from about 10 kcal to about 70 kcal per serving.

### Cereal Beta-Glucan

The nutritional compositions comprise a cereal beta-glucan. Any source of the cereal beta-glucan that is known or otherwise suitable for use in an oral nutritional product is also suitable for use herein, provided that such a source is also compatible with, or is otherwise rendered to be compatible with, the other selected ingredients in the composition.

The cereal beta-glucan suitable for use herein is sourced from grains as opposed to and as distinguished from yeast and mushroom-derived beta-glucan. Beta-glucans are a class of soluble dietary fibers that are polysaccharides that, when taken with a meal, may result in a slower rate of carbohydrate and lipid absorption. Cereal beta-glucans are linear chains of β-D-glycopyranosyl units (1-3, 1-4-β-D-linked as compared to yeast-based beta-glucans that are 1-3, 1-6-β-D-linked) in which 70% of the units are typically linked, but which also consist of β-D-cellotriosyl and β-D-cellotetraosyl residues separated by linkages arranged in a random manner. The soluble nature of beta-glucans, in conjunction with their chemical structure, helps to increase the viscosity of foods that contain them.

Suitable cereal-based beta-glucans for use in the nutritional compositions of the present disclosure include oat-derived beta-glucans, barley-derived beta-glucans, and combinations thereof, with barley-derived beta-glucans being especially suitable. These specific beta-glucans, when combined with the Salacia extract described herein, act synergistically to control and regulate postprandial glucose levels such that glucose absorption into the bloodstream is retarded, thus lengthening the amount of time it takes a given amount of glucose to enter the bloodstream.

The beta-glucan source for use in the nutritional composition may comprise up to 100% by weight of a beta-glucan, including from about 5% to 100%, and also including from about 15% to 100%, and also including from about 50% to 100%, and also including from 50% to 95%, and also including from about 60% to about 85%, beta-glucan by weight of the beta-glucan source.

The cereal beta-glucan selected for use herein may have any weight average molecular weight suitable for the selected use and formulation, but will most typically range from about 50 kDa to about 1000 kDa, including less than 750 kDa, including from about 100 kDa to about 250 kDa.

One suitable commercially available source of a barley beta-glucan for inclusion in the nutritional composition is Barliv™ (70% barley beta-glucan), commercially available from Cargill (Panora, Iowa).

The nutritional compositions may comprise an amount of cereal beta-glucan sufficient to synergistically interact with the Salacia extract as described herein in providing the desired blood glucose control. The nutritional compositions most typically, however, comprise from about 5% to about 90%, including from about 10% to about 50%, also including from about 11% to about 46%, and also including from about 11% to about 25%, cereal beta-glucan by weight of the nutritional composition.

In some embodiments, the nutritional compositions may include at least 0.5 grams, including from 0.5 grams to about 4 grams, also including from about 1.1 grams to about 2.0 grams, and also including from about 0.77 grams to about 1.4 grams, of beta-glucan per serving of the nutritional composition.

### Resistant Starch

The nutritional compositions described herein additionally comprise a resistant starch. The cereal beta-glucan described above is agglomerated and/or co-dried with a resistant starch prior to, during, or after combining the cereal beta-glucan with the other ingredients of the nutritional composition.

Any source of a resistant starch that is known or otherwise suitable for use in an oral nutritional product is also suitable for use herein as an agglomerating or co-drying agent, provided that such a source is also compatible with, or is otherwise rendered to be compatible with, the other selected ingredients in the composition.

Suitable resistant starches for use in the nutritional compositions of the present disclosure include wheat-derived resistant starches, corn-derived resistant starches, and combinations thereof, with wheat-derived resistant starches being especially suitable. These specific resistant starches, when agglomerated or co-dried with the cereal beta-glucan described herein, may act to dissolve the fine fibrous structures inherent in the cereal beta-glucan matrices, forming larger particle clusters with visible fracture surfaces. This attachment/dissolution of the cereal beta-glucan by the resistant starch allows for improved cold water solubility, wetting properties, and dispersibility/mixability of the resulting nutritional composition including the cereal beta-glucan. Similar improved dispersibility can be obtained in a higher bulk density cereal beta-glucan, or through the co-drying process.

The resistant starch for agglomerating with the cereal beta-glucan of the nutritional composition is typically highly soluble in water, and thus, an aqueous solution of the resistant starch may include up to 80% by weight of a resistant starch, including from about 10% to 80%, and also including from about 20% to about 75%, and also including from about 25% to about 70%, and also including from about 30% to about 65%, resistant starch by weight of the aqueous solution.

One suitable commercially available source of a wheat-derived resistant starch suitable for agglomeration with the cereal beta-glucan in the nutritional composition is Nutriose®, as described above and commercially available from Roquette Freres (France).

The cereal beta-glucan is agglomerated with an amount of resistant starch sufficient to dissolve the fine fibrous structures of the cereal beta-glucan as described herein to provide a nutritional composition including the cereal beta-glucan with the desired cold water solubility, wetting properties, and dispersibility/mixability. The cereal beta-glucan most typically, however, is agglomerated with resistant starch in a weight ratio of cereal beta-glucan:resistant starch of from about 9:1 to about 1:3, including from about 2:1 to about 1:2, and including about 1:1.

### Salacia Extract

The nutritional compositions may comprise a Salacia extract. Any source of the extract that is known or otherwise suitable for use in an oral nutritional product is also suitable for use herein, provided that such a source is also compatible with, or is otherwise rendered to be compatible with, the other selected ingredients in the composition.

The Salacia extract suitable for use herein may include a Salacia oblonga extract and or a Salacia reticula extract, either of which contains at least one of the alpha-glucosidase inhibitors salacinol, kotalanol and mangiferin 9, which have been shown to inhibit the activity of intestinal alpha-glucosidases and mitigate blood glucose responses upon ingestion of food.

Suitable Salacia oblonga extracts for use in the nutritional compositions include both powdered and liquid forms of Salacia oblonga extracts. One specific example of a suitable Salacia oblonga extract is Salacia oblonga Extract A or Salacia oblonga Extract D (both powdered forms), commercially available from Tanabe Seiyaku Company Limited (Osaka, Japan).

The nutritional compositions may comprise an amount of Salacia extract sufficient to synergistically interact with the beta-glucan component of the composition in providing the desired blood glucose control. The nutritional compositions most typically, however, include from about 0.5% to about 20%, including from about 0.5% to about 20%, including from about 1% to about 5%, also including from about 1% to about 4%, and also including from about 1% to about 2%, Salacia extract by weight of the nutritional composition.

The nutritional compositions most typically comprise Salacia extract in amounts ranging from at least 0.05 grams, including from about 0.1 to about 1.0 grams, and also including from about 0.1 grams to about 0.2 grams, and also including from about 0.1 grams to about 0.18 grams, of the extract per serving of the nutritional composition.

The Salacia extract in the nutritional compositions may also be characterized in terms of its alpha-glucosidase inhibitory activity expressed as IC50 (50% inhibitory concentration). The alpha-glucosidase inhibitors in the Salacia extract are salacinol and/or kotalanol. The IC50 inhibitory concentration for the alpha-glucosidases may be from about 50 to about 60 micrograms per milliliter. In one specific example, Salacia oblonga extract D, which has an IC50 of not more than 50 micrograms per milliliter, can be used in the nutritional compositions.

### Filler Material

The nutritional compositions described herein may further comprise a filler material to augment the bulk properties of the nutritional compositions. These filler materials may include any such material suitably known for or otherwise suitable for use in a nutritional composition.

The filler material may include any nutritional ingredient that adds bulk to the composition, and in most instances will be substantially inert, and does not significantly negate the blood glucose benefits of the nutritional composition. The filler material most typically includes a fiber and or carbohydrate having a low glycemic index, although it is understood that other non-carbohydrate fillers as well as high glycemic index carbohydrate fillers may be used, although less desirably.

The filler material, including any carbohydrate or fiber filler material, may represent enough of the finished product to provide the desired bulk or flow properties, but most typically represents from about 5% to about 90%, including from about 30% to about 90%, including from about 40% to about 85%, also including from about 50% to about 85%, and also including from about 75% to about 80%, by weight of the nutritional composition.

Any carbohydrate source suitable for use in a nutritional composition is also suitable for use as a filler material in the nutritional compositions described herein. Such carbohydrates, however, may advantageously include those having a low glycemic index such as fructose and low DE maltodextrins as such ingredients do not introduce a high glycemic load into the nutritional composition. Other suitable carbohydrate filler material includes any dietary fiber suitable for use in a nutritional product, including soluble and insoluble fiber, especially fructooligosaccharides. The filler material may be selected such that it does not negatively impact the synergistic nature of the beta-glucan and Salacia extract combination described herein.

Non-limiting examples of commercially available filler materials for use herein include, resistant starches, Sunfiber® (Taiyo International, Inc., Minneapolis, Minn.), which is a water-soluble dietary fiber produced by the enzymatic hydrolysis of Guar beans; Fibersol 2™ (Archer Daniels Midland Company, Bloomington, Ill.), which is a digestion resistant maltodextrin; and Nutriose® (Roquette Freres, France), which is a resistant wheat dextrin starch/fiber having extended energy release and typically is used as a sugar substitute. In those embodiments when one or more resistant starches are used as a filler material, these filler material resistant starches are separate and apart from any resistant starches that are agglomerated or co-dried with the cereal beta-glucans as described herein; that is, the resistant starch may be agglomerated and/or co-dried with the cereal beta-glucan to form the agglomerated and/or co-dried particulates and additional resistant starch that is not agglomerated and/or co-dried with the cereal beta-glucan may be included in the nutritional products as a filler material.

### Optional Ingredients

The nutritional composition of the present disclosure may further comprise other optional ingredients that may modify the physical, chemical, aesthetic or processing characteristics of the compositions. Many such optional ingredients are known or otherwise suitable for use in nutritional products and may also be used in the nutritional compositions described herein, provided that such optional ingredients are safe and effective for administration and are compatible with the essential and other selected components in the compositions.

In some embodiments, the nutritional compositions may include a fat source, a protein source, a flowing agent, a stabilizer, a preservative, an anti-oxidant, an acid, a buffer, a pharmaceutical active, a sweetener, an intense sweetener, a colorant, a flavor, a flavor enhancer, an emulsifying agent, an anti-caking agent, a lubricant, and so forth, as well as any combination thereof. Although it is within the scope of the present disclosure for the nutritional composition to include a fat source and/or a protein source, it is generally preferred that the nutritional composition be fat free and/or protein free. When included, the fat and/or protein source may be any conventional fat or protein source suitable for use in powdered nutritional compositions.

A flowing agent or anti-caking agent may be included in the nutritional compositions as described herein to retard clumping or caking of the powder over time and to make a powder embodiment flow easily from its container. Any known flowing or anti-caking agents that are known or otherwise suitable for use in a nutritional powder or product form are suitable for use herein, non-limiting examples of which include tricalcium phosphate, silicates, and combinations thereof. The concentration of the flowing agent or anti-caking agent in the nutritional composition varies depending upon the product form, the other selected ingredients, the desired flow properties, and so forth, but most typically range from about 0.1% to about 4%, including from about 0.5% to about 2%, by weight of the nutritional composition.

A stabilizer may also be included in the nutritional compositions. Any stabilizer that is known or otherwise suitable for use in a nutritional product is also suitable for use herein, some non-limiting examples of which include gums such as xanthan gum. The stabilizer may represent from about 0.1% to about 5.0%, including from about 0.5% to about 3%, including from about 0.7% to about 1.5%, by weight of the nutritional composition.

The nutritional compositions may further comprise minerals suitable for use in a nutritional product, non-limiting examples of which include phosphorus, sodium, chloride, magnesium, manganese, iron, copper, zinc, iodine, calcium, potassium, chromium, chromium picolinate, molybdenum, selenium, and combinations thereof. Chromium picolinate is particularly useful in the nutritional compositions.

The nutritional composition may further comprise any vitamins or similar other materials suitable for use in a nutritional product, some non-limiting examples of which include carotenoids (e.g., beta-carotene, zeaxanthin, lutein, lycopene), biotin, choline, inositol, folic acid, pantothenic acid, vitamin A, thiamine (vitamin B1), riboflavin (vitamin B2), niacin (vitamin B3), pyridoxine (vitamin B6), cyanocobalamin (vitamin B12), ascorbic acid (vitamin C), vitamin D, vitamin E, vitamin K, and various salts, esters or other derivatives thereof, and combinations thereof. Vitamin C, vitamin D, and or vitamin B12 are particularly useful in the nutritional composition.

### Manufacture

The nutritional compositions may be prepared by any known or otherwise effective manufacturing technique for preparing the powder or other selected product form. Many such techniques are known and may be applied by one of ordinary skill in the art to the nutritional compositions described herein.

One particularly desirable manufacturing method includes the dry blending of the selected ingredients to form a dry blended powder. In this process, for example, the beta-glucan, Salacia extract, filler material, and any other optional materials, each in dry form, are combined as such and thoroughly mixed in a suitable mixing apparatus to form a dry blended nutritional composition in powder form. The resulting dry blended composition may then be packaged in any desired size and material suitable for containing nutritional compositions in powder form.

In one desirable embodiment, the cereal beta-glucan is further agglomerated or co-dried with a resistant starch prior to, during, or after dry blending with the other selected ingredients to prepare the nutritional composition. The cereal beta-glucan may be agglomerated with the resistant starch in either liquid or powder form, however, spraying the cereal beta-glucan with an aqueous solution including the resistant starch has been found particularly suitable. Alternatively, the cereal beta-glucan can be mixed with a resistant starch in solution, and dried together. Additionally, the cereal beta-glucan/resistant starch particles may have a mean particle diameter of from about 50 microns to about 700 microns.

Further, the cereal beta-glucan may be agglomerated with the resistant starch prior to or after drying the cereal beta-glucan. It should be recognized, however, that as the cereal beta-glucan is generally poorly soluble in cold water, if a liquid form of cereal beta-glucan is to be agglomerated with the resistant starch, the cereal beta-glucan may be in a heated aqueous solution; that is, a solution having a temperature above room temperature (above 25° C.). A heated aqueous solution typically includes up to 80% by weight of cereal beta-glucan, including from about 10% to 80%, and also including from about 20% to about 75%, and also including from about 25% to about 70%, and also including from about 30% to about 65%, cereal beta-glucan by weight of the aqueous solution.

Further, the cereal beta-glucan may suitably be agglomerated or co-dried with the resistant starch directly prior to being dry blended with the other ingredients in the nutritional composition, or can be dry blended with the other ingredients of the nutritional composition, and subsequently, the nutritional composition including the cereal beta-glucan may be agglomerated or co-dried with the resistant starch. It has been found particularly advantageous to agglomerate or co-dry the cereal beta-glucan directly with the resistant starch prior to dry blending with the other ingredients of the nutritional composition as this reduces the agglomeration or co-drying required to only 20% to 30% of the nutritional composition, thereby proving a more economical agglomeration or co-drying than agglomeration or co-drying of the entire nutritional composition. Further, by agglomerating or co-drying the cereal beta-glucan and the resistant starch and drying the agglomerated or co-dried cereal beta-glucan prior to dry blending with the other ingredients, drying time and drying cost are reduced.

The nutritional compositions may, of course, be manufactured by other known or otherwise suitable techniques not specifically described herein without departing from the spirit and scope of the present disclosure. The present embodiments are, therefore, to be considered in all respects as illustrative and not restrictive and that all changes and equivalents also come within the description of the present disclosure.

### Methods of Use

The nutritional compositions may be used in accordance with the methods of the present disclosure, wherein such methods comprise the oral administration of the nutritional compositions described herein to individuals in need of blood glucose control, especially for modulating the blood glucose response during and or after a meal, including a carbohydrate-containing meal.

In accordance with the methods described herein, the term blood glucose control means a delay in the peak blood glucose response following a meal, a reduced blood glucose peak level following a meal, and/or a reduced blood glucose AUC following a meal.

The methods are especially useful in individuals afflicted with prediabetes, individuals afflicted with type 2 diabetes, overweight or obese individuals, individuals with impaired glucose tolerance, individuals at risk for developing diabetes, or other individuals who may otherwise benefit from the blood glucose control benefits made possible by the methods and compositions described herein.

In accordance with the methods described herein, the nutritional compositions may be administered to or orally consumed by an individual before, during, or after a meal to control blood glucose levels as defined herein.

In one embodiment of the methods described herein, the nutritional product in powder form is reconstituted water, tea or other suitable liquid and then orally consumed by an individual before, during, or after a meal. Typically, when used in powder form to be reconstituted with liquid, the cereal beta-glucan in the nutritional composition is agglomerated or co-dried with a resistant starch so as to improve the cold water solubility, wetting properties, and dispersion of the nutritional composition in the liquid. The reconstitution can be done in any suitable container including, for example, a tumbler, shaker, bottle, and the like.

In another embodiment of the methods described herein, the nutritional product in powder form is sprinkled on food before it is consumed such that the nutritional composition in powder form is ingested during the meal.

The nutritional compositions may be administered to or consumed by the individual with one or more carbohydrate-containing or other meals per day, and or may be administered to or consumed by the individual once daily, twice daily, three times a day, four times a day or even more times per day to provide the desired blood control in the individual. The nutritional composition may be administered to or consumed by the individual within 0 to 60 minutes of the meal, including within 1 to 30 minutes of the meal, and including during the meal.

### EXAMPLES

The following Examples illustrate specific embodiments and or features of the nutritional compositions and methods of the present disclosure. The Examples are given solely for the purpose of illustration and are not to be construed as limitations, as many variations thereof are possible without departing from the spirit and scope of the disclosure.

### Example 1

In this Example, the effect of various water-soluble dietary fibers (Sunfibre®, Nutriose®, WPG™ Yeast Beta-Glucan and Barliv™), alone or in combination with Salacinol (Salacia oblonga extract D), on postprandial glucose levels at 30 minutes are analyzed. Pre-diabetic (obese rats) and diabetic animal models are evaluated.

Postprandial blood glucose levels are evaluated in the prediabetic (obese) and diabetic Zucker male rats and in diabetic male mice at the age of approximately 6-8 weeks. Initially, the body weights of the animals are recorded before fasting and basal blood glucose measurements are taken. The animals fast overnight and are then randomized based on their basal glucose levels and assigned into different experimental groups (n=5 to 7 per group).

Various sample compositions of water-soluble fibers and or Salacinol are prepared. To formulate the sample compositions, a corn starch suspension is first prepared by mixing 1 gram of corn starch with 10 ml of 0.5% Tween-80 in distilled water. The water-soluble fiber and or Salacinol are then slowly added to and mixed with the corn starch suspension at the concentrations described in the following table.

| Sample | | | | | |
|---|---|---|---|---|---|
| (mg/ | | | | | |
| Kg) | Sunfibre ® | Nutriose ® | Barliv ™ | WPG ™ | Salacinol |
| 1 | 600 | — | — | | — |
| 2 | 600 | — | — | | 12.5 |
| 3 | 1000 | — | — | | — |
| 4 | 1000 | — | — | | 12.5 |
| 5 | — | 100 | — | | — |
| 6 | — | 100 | — | | 6.25 |
| 7 | — | — | 100 | | — |
| 8 | — | — | 100 | | 6.25 |
| 9 | — | — | 200 | | — |
| 10 | — | — | 200 | | 12.5 |
| 11 | — | — | — | | 6.25 |
| 12 | — | — | — | | 12.5 |
| 13 | — | — | — | — | 6.25 |
| 14 | — | — | — | 100 | 6.25 |

The compositions summarized above in the table are administered to the animals (where mg/kg of sample refers to mg of fiber or Salacinol per kg of body weight of the animals) as a single oral dose (10 ml/kg body weight) to the animals. After 30 minutes, the blood-glucose levels of the animals are tested using a glucometer and test strips (One Touch Ultra Lifescan, available from Johnson & Johnson, San Jose, Calif.). The tail of each animal is wiped clean with absorbent cotton and a drop of blood is obtained from the tip. Each sample of blood is placed on a sampling area of the glucometer strip.

Results are expressed as means±SEM as percent change in glucose (mg/dl). Statistical analysis is performed by t-test for blood glucose levels. The results are shown in the following table.

| | | Diabetic | | | | Diabetic | | Diabetic |
|---|---|---|---|---|---|---|---|---|
| | Obese Rat | Rat | Obese Rat | Obese Rat | Diabetic Rat | Rat | Obese Rat | Mouse |
| Dosage (mg/Kg) | Sunfiber ® | Sunfiber ® | Nutriose ® | Barliv ™ | Barliv ™ | WPG ™ | Barliv ™ | Barliv ™ |
| | 600 | 1000 | 100 | 100 | 100 | 100 | 200 | 200 |
| | Saliconol | Saliconol | Salacinol | Salacinol | Salacinol | Salacinol | Salacinol | Salacinol |
| | 12.5 | 12.5 | 6.25 | 6.25 | 6.25 | 6.25 | 12.5 | 12.5 |
| Sunfibre ® | 27.4 | 37.5 | — | — | — | — | — | — |
| Nutriose ® | — | — | −1.80 | — | — | — | — | — |
| Barliv ™ | — | — | — | −6.1 | 1.3 | — | 2.7 | −17.5 |
| WPG ™ | — | — | — | — | — | −4.87 | — | — |
| Salacinol | −51.1 | −59.5 | −22.75 | −9.8 | 3.8 | −10.12 | −12.2 | −11.1 |
| Sunfibre ® + Salacinol | −27.1 | −27.5 | — | — | — | — | — | — |
| Nutriose ® + Salacinol | — | — | −19.41 | — | — | — | — | — |
| Barli ™ + Salacinol | — | — | — | −27.6 | −11.3 | — | −21.2 | −70.4 |
| WPG ™ + Salacinol | — | — | — | — | — | −9.55 | — | — |
| Observed Effect | Inhibition | Inhibition | No synergy | Synergy | Synergy | No synergy | Synergy | Synergy |

In the diabetic rat, obese rat, and diabetic mouse models, the combination of Barliv™ and Salacinol at varied concentrations shows significant synergistic activity in reducing postprandial glucose levels at 30 minutes. Sunfibre® shows significant inhibition of Salacinol activity on postprandial levels at all concentrations tested. Nutriose®, alone or in combination with Salacinol, does not show a significant effect on postprandial glucose levels. Additionally, the yeast-derived beta-glucan (WPG™ Beta-Glucan) in combination with the Salacinol showed a neutral, non-synergistic effect.

Based on these animal study results, the combination of Barliv™ (a cereal-based beta-glucan) and Salacinol produces a synergistic effect on postprandial glucose levels as compared to an inhibitory effect or no effect at all for the other fibers in combination with Salacinol.

### Example 2

In this Example, blood glucose lowering effects of barley-derived beta-glucan (Barliv™) and yeast-derived beta-glucan (WGP™) in pre-diabetic (obese) and diabetic animal models are compared. The effects are evaluated at postprandial time points of 30 minutes, 60 minutes, 90 minutes, and 120 minutes.

The effect on postprandial blood glucose levels is evaluated in obese and diabetic Zucker male rats and in diabetic male mice at the age of approximately 6-8 weeks. Initially, the body weights of the animals are recorded before fasting and before basal glucose measurements. The animals fast overnight and are then randomized based on their basal glucose level and assigned into 3 different experimental groups (n=9 per group).

A corn starch suspension is prepared by mixing 1 gram of corn starch with 10 ml of 0.5% Tween-80 in distilled water. This corn starch suspension is administered to the control group. A second suspension is prepared using the corn starch suspension prepared in the control group and slowly mixing Barliv™ (100 mg/kg) therein. Additionally, a third suspension is prepared by slowly mixing the corn starch suspension of the control group with yeast whole beta-glucan particle (WGP™) (100 mg/Kg).

The compositions are administered to their respective experimental group at a single oral dosage (10 ml/kg body weight) to the animals. After 30 minutes, 60 minutes, 90 minutes, and 120 minutes, the blood-glucose levels of the animals are tested using a glucometer and test strips (One Touch Ultra Lifescan, available from Johnson & Johnson). The tail of each animal is wiped clean with absorbent cotton and a drop of blood is obtained from the tip and placed on the sampling area of the glucometer strip.

Results are expressed as % change in AUC±SEM. Statistical analysis is performed by t-test for blood glucose levels and one-way ANOVA followed by Dunnett's multiple comparison for AUC using graph pad prism software (significance at P<0.05). The AUC (0−120 min) values expressed as percent change in blood glucose level are shown in the following table.

| | % change in AUC |
|---|---|
| | (0-120 min) |
| Cornstarch Control Group | 0 |
| Barliv ™ Group | −18.1% |
| WCP ™ Group | 3.9% |

The administration of Barliv™ with the corn starch solution shows a significant glucose lowering effect in the mice as compared to the administration of WGP™ in the same animal model. The data further shows that WGP™ does not lower blood glucose levels at all.

### Example 3

In this Example, the dispersibility and mixability of barley-derived beta-glucan (Barliv™) in water are analyzed. Particularly, the effects of various treatments on the ability of the nutritional composition including Barliv™ to disperse in water are analyzed. The mixing protocol used simulated an end-user and the test sample was introduced into eight ounces of water at room temperature and was stirred 10 times clockwise and 10 times counter-clockwise inside of a 12 ounce glass using a standard spoon. The end product was visually examined for the presence of clumps, sedimentation and/or segregated layers.

The various nutritional compositions including Barliv™ are described in the table below. The compositions are subjected to one of the following treatments as further indicated in the table and described below:

Dry blending: separation of the Barliv™ particles using filler materials with better wetting properties.

Agglomeration: instantization of the Barliv™ particles with a wetting agent (e.g., lecithin), or binding them with a weighing agent (e.g., fructose).

Integral Spray Drying: integration of ingredients with suitable properties in the core particle structure through dissolving together in a liquid phase followed by co-spray drying.

Grinding: reduction in the size of the filament-like structures and increasing the bulk density of Barliv™

| | Ingredients (g/5 g stichpack) | | | | | | | |
|---|---|---|---|---|---|---|---|---|
| | Salacia | | Carbohydrate | V/M | | | Lecithin | |
| | Extract D | Barliv ™ | Filler | Premix | | Tricalcium | (Solae | |
| Sample | (Tanabe) | (Cargill) | Material | (Fortitech) | Stabilizer | Phosphate | LLC) | Treatment Method |
| 1 | 0.180 | 1.100 HP | 3.245 | 0.250 | 0.100 | 0.100 | 0.025 | Dry Blended |
| 2 | 0.180 | 1.100 HP | 3.245 | 0.250 | 0.100 | 0.100 | 0.050 | Agglomerated |
| 3 | 0.180 | 0 | 3.245 | 0.250 | 0.100 | 0.100 | 0.025 | Dry Blended |
| 4 | 0.180 | 1.100 HP | 3.245 | 0.250 | 0.100 | 0.100 | 0.025 | Dry Blended 3.72 g |
| | | | | | | | | Maltrin ® with Salacia |
| | | | | | | | | Extract D and Barliv ™ |
| | | | | | | | | prior to adding |
| | | | | | | | | remaining ingredients of |
| | | | | | | | | composition |
| 5 | 0.180 | 1.100 HP | 3.245 | 0.250 | 0.100 | 0.100 | 0.1125 | Agglomerated |
| 6 | 0 | 1.100 HP | 1.100 | 0 | 0 | 0 | 0 | Agglomerated 150 g |
| | | | | | | | | sample of prepared |
| | | | | | | | | composition with 20 g |
| | | | | | | | | Fructose solution |
| 7 | 0.180 | 1.100 HP | 3.245 | 0.250 | 0.100 | 0.100 | 0.025 | Agglomerated 400 g |
| | | | | | | | | sample of prepared |
| | | | | | | | | composition with 25 g |
| | | | | | | | | Nutriose ® solution |
| 8 | 0 | 1.100 LP | 0 | 0 | 0 | 0 | 0 | Co-spraydry Barliv ™ |
| | | | | | | | | and Nutriose ® (1:2) |
| 9 | 0 | 1.100 LP | 0 | 0 | 0 | 0 | 0.10 | Co-spraydry Barliv ™ |
| | | | | | | | | and lecithin with |
| | | | | | | | | Nutriose ® and Fructose |
| | | | | | | | | (Barliv ™:Nutriose ®:Fructose |
| | | | | | | | | 1:2:1) |
| 10 | 0 | 1.100 LP | 0 | 0 | 0 | 0 | 0.10 | Co-spraydry Barliv ™ |
| | | | | | | | | and lecithin with |
| | | | | | | | | Maltrin ® and Fructose |
| | | | | | | | | (Barliv ™:Maltrin ®: |
| | | | | | | | | Fructose 1:1:1) |
| 11 | 0.180 | 1.100 LP | 0 | 0 | 0 | 0 | 0.10 | Grind Salacia Extract, |
| | | | | | | | | Barliv ™, and lecithin |
| | | | | | | | | with Nutriose ® and |
| | | | | | | | | Fructose |
| | | | | | | | | (Barliv ™:Nutriose ®:Fructose |
| | | | | | | | | 1:2:1) |
| 12 | 0.180 | 1.100 LP | 0 | 0 | 0 | 0 | 0.10 | Grind Salacia Extract, |
| | | | | | | | | Barliv ™, and lecithin |
| | | | | | | | | with Matrin ® |
| | | | | | | | | (Barliv ™:Matrin ® 1:2) |
| 13 | 0.180 | 1.100 LP | 3.245 | 0.250 | 0.100 | 0.100 | 0.025 | Dry Blended |

* HP = High Protein (6% by weight protein); LP = Low Protein (<3% by weight protein)

The results of the treatments are shown in the table below.

| Composition Sample | Observation |
|---|---|
| 1 | Particles floating on surface of water; fish eyes form; a cloudy layer forms on top; |
| | layer does not disperse upon stirring. |
| 2 | Particles floating on surface of water; fish eyes form; a cloudy layer forms on top; |
| | layer does not disperse upon stirring. |
| 3 | Particles drop down to bottom; sample disperses well; cloudy layer forms on bottom |
| | after 15-20 minutes, but disperses upon stirring; BETTER MIXABILITY |
| 4 | Particles floating on surface of water; fish eyes form; a cloudy layer forms on top; |
| | layer does not disperse upon stirring |
| 5 | Particles floating on surface of water; fish eyes form; a cloudy layer forms on top; |
| | layer does not disperse upon stirring |
| 6 | Particles floating on surface of water; fish eyes form; a cloudy layer forms on top; |
| | layer does not disperse upon stirring |
| 7 | Particles drop down to bottom; sample disperses well; thick cloudy layer forms on |
| | top after 10 minutes, but disperses upon stirring; IMPROVED MIXABILITY |
| 8 | Particles floating on surface of water; fish eyes form; a cloudy layer forms on top; |
| | layer does not disperse upon stirring |
| 9 | Particles floating on surface of water; fish eyes form; a cloudy layer forms on top; |
| | layer does not disperse upon stirring |
| 10 | Particles floating on surface of water; fish eyes form; a cloudy layer forms on top; |
| | layer does not disperse upon stirring |
| 11 | Particles floating on surface of water; fish eyes form; a cloudy layer forms on top; |
| | layer does not disperse upon stirring |
| 12 | Particles floating on surface of water; fish eyes form; a cloudy layer forms on top; |
| | layer does not disperse upon stirring |
| 13 | Particles floating on surface of water; fish eyes form; a cloudy layer forms on top; |
| | layer does not disperse upon stirring |

As shown in the above table, except for agglomeration using a Nutriose® solution, none of the treatments improve the dispersibility and/or mixability of the Barliv™. Specifically, dry blending and agglomeration with different combinations of ingredients does not improve bulk density, formation of fish-eyes, and segregation of layers. Similarly, grinding fails to improve bulk density and wetting properties. Co-spray drying with fructose, maltodextrin (Maltrin®), or lecithin, and using a small scale dryer produces a very fine material with low bulk density and poor wetting properties. Numerous fibrous structures are also formed inside the drying chamber, often causing extreme fouling of the dryer. It is observed that formation and growth of these string-like fibrous structures are favored by the spray drying process. Even a smaller quantity of Barliv™ in solution with three-four times fructose, Nutriose®, or Maltrin® plays a dominating role in defining the physical characteristics of the dried powder. Based on these observations, it can be said that the spray drying process may not be an ideal method of improving the dispersibility and/or mixability of Barliv™. Due to the small scale dryer and its inherent limitations resulting in poor wetting properties, co-spray drying with Nutriose® also did not show any significant improvement. However, results similar to the resistant starch agglomerated cereal beta-glucan may be obtained through co-drying on a commercial scale drier.

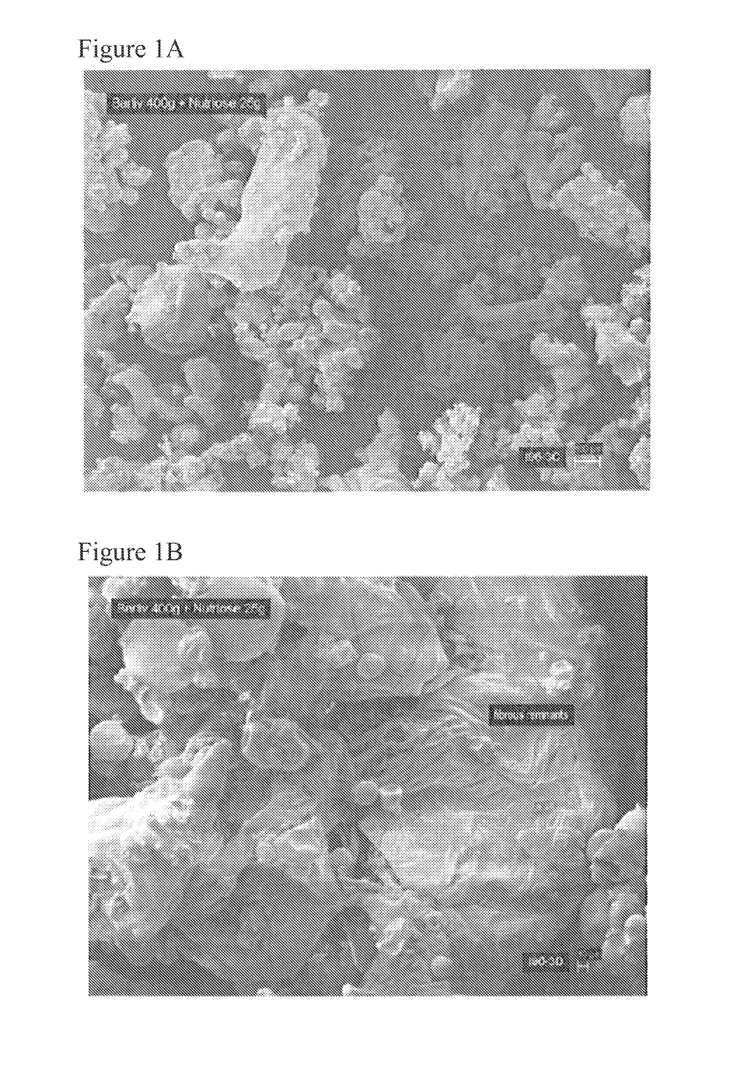

Agglomeration with fructose, lecithin, water or Maltrin® also does not improve the wetting properties, except when conducted with Nutriose®. Scanning electron microscopy (SEM) images (FIGS. 1A and 1B) confirm that spraying a Nutriose® solution during agglomeration is effective in dissolving the fine fibrous structures forming larger particle clusters with visible fracture surfaces. In some larger clusters, remnants of the fibers are still discernibly inscribed with more solid structures. Dispersibility and mixability of the Barliv™ is enhanced by this attachment/dissolution of Nutriose® on its structure. It is also found that the round hollow grains are broken up by the hot drying/fluidizing air present during the agglomeration process.

### Examples 4-12

Examples 4-12 illustrate selected embodiments of the nutritional compositions of the present disclosure, which embodiments include combinations of Barliv™ and Salacia oblonga extract. The exemplified formulations are described in the table below. The percentage of each ingredient is the weight percent of the ingredient based on the total weight of the nutritional composition, and the number in parentheses (where shown) is the amount, in grams, of the ingredient per serving. Example 12 illustrates a lemon flavored embodiment of the nutritional compositions of the present disclosure, which embodiment includes a combination of Barliv™ and Salacia oblonga extract. Example 12 illustrates a flavored embodiment that provides 2.0 g of Barliv™ and 0.12 g of Salacia per serving.

These powdered nutritional compositions are prepared by dry mixing the ingredients together and/or agglomerating the mixture to have improved mixability. The formulations may be used directly, such as sprinkled directly on food, or may be reconstituted with water or tea prior to use to the desired target ingredient concentrations.

| Ingredient | Example 4 | Example 5 | Example 6 | Example 7 |
|---|---|---|---|---|
| Barliv ™ | 46.22% (1.1) | 11% (1.1) | 20% (2.0) | 22% (1.1) |
| Salacia Extract | 7.56% (0.18) | 1.8% (0.18) | 1.2% (0.12) | 3.6% (0.18) |
| Nutriose ® | — | 60% (6.0) | 50% (5.0) | 66% (3.3) |
| Agglomerated Maltodextrin | 42.02% (1.0) | 10% (1.0) | — | — |
| Maltodextrin-M100 | — | — | — | 1.33% (0.0667) |
| Fructooligosaccharides | — | 5.2% (0.52) | 16.8% (1.68) | — |
| Fructose | — | 10% (1.0) | 10% (1.0) | — |
| Tricalcium phosphate | — | 1.0% (0.1) | 1.0% (0.1) | 2.0% (0.1) |
| Xanthan gum | 4.2% (0.1) | 1.0% (0.1) | 1.0% (0.1) | 1.4% (0.07) |
| Vitamin C | — | — | — | 3.6% (0.18) |
| Vitamin D | — | — | — | 0.03% (0.0015) |
| Vitamin B12 | — | — | — | trace |
| Chromium Picolinate | — | — | — | 0.035% (0.00177) |
| Ingredient | Example 8 | Example 9 | Example 10 | Example 11 |
| Barliv ™ | 46.22% | 11% | 15% | 22% |
| Salacia Extract | 7.56% | 1.8% | 1.2% | 4.6% |
| Nutriose ® | — | 40% | 50% | 65% |
| Agglomerated Maltodextrin | 38.02% | 10% | 10% | — |
| Maltodextrin-M100 | 2.00% | 20.0% | 5.00% | 1.33% |
| Fructooligosaccharides | — | 5.2% | 6.8% | — |
| Fructose | 2.00% | 10% | 10% | — |
| Tricalcium phosphate | — | 1.0% | 1.0% | 2.0% |
| Xanthan gum | 4.2% | 1.0% | 1.0% | 1.4% |
| Vitamin C | — | — | — | 3.6% |
| Vitamin D | — | — | — | 0.03% |
| Vitamin B12 | — | — | — | Trace |
| Chromium Picolinate | — | — | — | 0.035% |

| Ingredient | Example 12 |
|---|---|
| Salacia Extract | 1.2% (0.12) |
| Barliv ™ | 20% (2) |
| Nutriose ® | 50% (5) |
| Fructooligosaccharides | 9.7% (0.97) |
| Fructose | 10.0% (1) |
| Lemon Flavor | 4.0% (0.4) |
| Citric Acid | 3.0% (0.3) |
| Tricalcium Phosphate | 1.0% (0.1) |
| Xanthan Gum | 1.0% (0.1) |
| Sucralose | 0.1% (0.01) |

What is claimed is:

1. A nutritional composition comprising particles comprising a cereal beta-glucan and a resistant starch, wherein the particles are selected from the group consisting of agglomerated particles, co-dried particles, and combinations thereof.

2. The nutritional composition of claim 1 wherein the cereal beta-glucan is selected from the group consisting of oat beta-glucan, barley beta-glucan, and combinations thereof.

3. The nutritional composition of claim 1 wherein the resistant starch is selected from the group consisting of resistant starch derived from wheat, resistant starch derived from corn, and combinations thereof.

4. The nutritional composition of claim 1 wherein the nutritional composition is a powdered composition.

5. The nutritional composition of claim 4 wherein the particles comprise a barley beta-glucan and a resistant starch derived from wheat.

6. The nutritional composition of claim 5 wherein the powdered composition further includes a Salacia extract.

7. The nutritional composition of claim 6 wherein the Salacia extract is selected from the group consisting of Salacia oblonga extract, Salacia reticula extract, and combinations thereof.

8. The nutritional composition of claim 1 wherein the agglomerated particles have a mean particle diameter of from about 50 to about 700 microns.

9. A method of improving the cold water solubility of a powdered nutritional composition comprising a cereal beta-glucan, the method comprising agglomerating the cereal beta-glucan with a resistant starch.

10. The method of claim 9 wherein the cereal beta-glucan is selected from the group consisting of oat beta-glucan, barley beta-glucan, and combinations thereof.

11. The method of claim 9 wherein the resistant starch is selected from the group consisting of a resistant starch derived from wheat, a resistant starch derived from corn, and combinations thereof.

12. The method of claim 9 wherein the agglomerated cereal beta-glucan and resistant starch are combined with selected ingredients to form the nutritional composition, wherein the combining occurs through a method selected from the group consisting of agglomeration, co-drying, dryblending, and combinations thereof.

13. The method of claim 9 wherein agglomerating the cereal beta-glucan with the resistant starch comprises dry blending the ingredients of the nutritional composition together and then agglomerating the dry blended nutritional composition comprising the cereal beta-glucan with the resistant starch.

14. The method of claim 9 wherein the nutritional composition further comprises a Salacia extract selected from the group consisting of Salacia oblonga extract, Salacia reticula extract, and combinations thereof.

15. A method of improving the cold water solubility of a powdered nutritional composition comprising a cereal beta-glucan, the method comprising co-drying the cereal beta-glucan with a resistant starch.
